(19) United States
(12) Patent Application Publication
(10) Pub. No.: US 2026/0327809 A1
(43) Pub. Date: Oct. 22, 2026

(54) Method and System for Protecting a Corrodible Substrate

(71) Applicant: U.S. Corrosion Technologies, LLC, Garland, TX (US)

(72) Inventors: Anthony Iannarelli, Garland, TX (US); Mark Wilson, Katy, TX (US); Joe D. Hill, Garland, TX (US)

(21) Appl. No.: 19/635,867

(22) Filed: Apr. 1, 2026

Related U.S. Application Data
(60) Provisional application No. 63/792,691, filed on Apr. 22, 2025.

(51) Int. Cl. C23F 11/173; C08J 5/24; C09D 5/08; C09D 191/00

(52) U.S. Cl. CPC C23F 11/173; C08J 5/249; C09D 5/08; C09D 191/00; C08J 2391/00

(57) ABSTRACT

The present disclosure is directed to a method for protecting a corrodible substrate, including: applying a corrosion inhibiting composition to a corrodible substrate with a first wrap; and applying a second wrap over the first wrap, the second wrap including an uncured resin configured to be cured after applying the second wrap over the first wrap. The present disclosure is also directed to a corrosion inhibiting system, including: a corrosion inhibiting composition and a first wrap configured to be applied over a corrodible substrate; and a second wrap configured to be applied over the first wrap, the second wrap including an uncured resin configured to be cured after applying the second wrap over the first wrap.

### CROSS-REFERENCE TO RELATED APPLCATION

This application claims priority to U.S. Provisional Application No. 63/792,691, filed on Apr. 22, 2025, the entire disclosure of which is incorporated herein by reference.

### BACKGROUND

### Field

The present disclosure relates to protecting corrodible substrates and, in some non-limiting embodiments or aspects, to methods and systems for protecting corrodible substrates.

### Technical Considerations

Certain materials are susceptible to corrosion due to chemical reactions between atoms of the material and the surrounding environment. For example, metal materials may corrode via an oxidation reaction from the metal's atoms losing electrons to oxygen, particularly when exposed to moisture or other reactive elements. Corrosion of the material compromises the structural integrity of the component for which the material is used and can cause safety issues or require earlier and/or more frequent repair or replacement of the component.

### SUMMARY

The present disclosure relates to a method for protecting a corrodible substrate, including: applying a corrosion inhibiting composition to a corrodible substrate with a first wrap; applying a second wrap over the first wrap, the second wrap including an uncured resin configured to be cured after applying the second wrap over the first wrap.

In some non-limiting embodiments or aspects, the method may further include applying a coating composition over the cured second wrap.

In some non-limiting embodiments or aspects, the corrodible substrate may include a metal substrate.

In some non-limiting embodiments or aspects, the metal substrate may include a metal pipe.

In some non-limiting embodiments or aspects, the metal substrate may include a marine component.

In some non-limiting embodiments or aspects, applying the corrosion inhibiting composition to the corrodible substrate with the first wrap may include: applying the corrosion inhibiting composition directly to the corrodible substrate; and applying the first wrap over the corrosion inhibiting composition.

In some non-limiting embodiments or aspects, applying the corrosion inhibiting composition to the corrodible substrate with the first wrap may include: impregnating the first wrap with the corrosion inhibiting composition; and applying the impregnated first wrap directly over the corrodible substrate.

In some non-limiting embodiments or aspects, the corrosion inhibiting composition may include a corrosion inhibitor configured to stop a corrosion-related reaction at a surface of the corrodible substrate over which the corrosion inhibiting composition is applied.

In some non-limiting embodiments or aspects, the corrosion inhibiting composition may include: a hydrotreated paraffinic petroleum distillate; and/or mineral spirits and crystalline silica.

In some non-limiting embodiments or aspects, the coating composition may include at least one of the following: a one-component polysiloxane composition, a one-component epoxy composition, a two-component epoxy composition, a (poly)urethane composition, a silicone composition, a rubberized composition, a fluoropolymer composition, a ceramic composition, a silicone-based conformal composition, and/or any combination thereof.

In some non-limiting embodiments or aspects, the method may further include exposing the second wrap to an environment in which the uncured resin moisture cures.

The present disclosure relates to a corrosion inhibiting system including: a corrosion inhibiting composition and a first wrap configured to be applied over a corrodible substrate; a second wrap configured to be applied over the first wrap, the second wrap including an uncured resin configured to be cured after applying the second wrap over the first wrap.

In some non-limiting embodiments or aspects, the system may include a coating composition applied over the cured second wrap.

In some non-limiting embodiments or aspects, the system may include the corrodible substrate, the corrosion inhibiting composition and the first wrap applied over the corrodible substrate.

In some non-limiting embodiments or aspects, the corrodible substrate may include a metal substrate.

In some non-limiting embodiments or aspects, the metal substrate may include a metal pipe.

In some non-limiting embodiments or aspects, the metal substrate may include a marine component.

In some non-limiting embodiments or aspects, the corrosion inhibiting composition may be applied directly to the corrodible substrate, and the first wrap may be applied directly over the corrosion inhibiting composition.

In some non-limiting embodiments or aspects, the corrosion inhibiting composition may be impregnated into the first wrap, and the impregnated first wrap may be applied directly over the corrodible substrate.

In some non-limiting embodiments or aspects, the corrosion inhibiting composition may include a corrosion inhibitor configured to stop a corrosion-related reaction at a surface of the corrodible substrate over which the corrosion inhibiting composition is applied.

In some non-limiting embodiments or aspects, the corrosion inhibiting composition may include: a hydrotreated paraffinic petroleum distillate; and/or mineral spirits and crystalline silica.

In some non-limiting embodiments or aspects, the coating composition may include at least one of the following: a one-component polysiloxane composition, a one-component epoxy composition, a two-component epoxy composition, a (poly)urethane composition, a silicone composition, a rubberized composition, a fluoropolymer composition, a ceramic composition, a silicone-based conformal composition, and/or any combination thereof.

The present disclosure also includes the following clauses.

Clause 1: A method for protecting a corrodible substrate, comprising: applying a corrosion inhibiting composition to a corrodible substrate with a first wrap; applying a second wrap over the first wrap, the second wrap comprising an uncured resin configured to be cured after applying the second wrap over the first wrap.

Clause 2: The method of clause 1, further comprising applying a coating composition over the cured second wrap.

Clause 3: The method of clause 1 or 2, wherein the corrodible substrate comprises a metal substrate.

Clause 4: The method of clause 3, wherein the metal substrate comprises a metal pipe.

Clause 5: The method of clause 3 or 4, wherein the metal substrate comprises a marine component.

Clause 6: The method of any of clauses 1-5, wherein applying the corrosion inhibiting composition to the corrodible substrate with the first wrap comprises: applying the corrosion inhibiting composition directly to the corrodible substrate; and applying the first wrap over the corrosion inhibiting composition.

Clause 7: The method of any of clauses 1-6, wherein applying the corrosion inhibiting composition to the corrodible substrate with the first wrap comprises: impregnating the first wrap with the corrosion inhibiting composition; and applying the impregnated first wrap directly over the corrodible substrate.

Clause 8: The method of any of clauses 1-7, wherein the corrosion inhibiting composition comprises a corrosion inhibitor configured to stop a corrosion-related reaction at a surface of the corrodible substrate over which the corrosion inhibiting composition is applied.

Clause 9: The method of any of clauses 1-8, wherein the corrosion inhibiting composition comprises: a hydrotreated paraffinic petroleum distillate; and/or mineral spirits and crystalline silica.

Clause 10: The method of any of clauses 2-9, wherein the coating composition comprises at least one of the following: a one-component polysiloxane composition, a one-component epoxy composition, a two-component epoxy composition, a (poly)urethane composition, a silicone composition, a rubberized composition, a fluoropolymer composition, a ceramic composition, a silicone-based conformal composition, and/or any combination thereof.

Clause 11: The method of any of clauses 1-10, further comprising: exposing the second wrap to an environment in which the uncured resin moisture cures.

Clause 12: A corrosion inhibiting system, comprising: a corrosion inhibiting composition and a first wrap configured to be applied over a corrodible substrate; a second wrap configured to be applied over the first wrap, the second wrap comprising an uncured resin configured to be cured after applying the second wrap over the first wrap.

Clause 13: The system of clause 12, further comprising: a coating composition applied over the cured second wrap.

Clause 14: The system of clause 12 or 13, further comprising: the corrodible substrate, the corrosion inhibiting composition and the first wrap applied over the corrodible substrate.

Clause 15: The system of any of clauses 12-14, wherein the corrodible substrate comprises a metal substrate.

Clause 16: The system of clause 15, wherein the metal substrate comprises a metal pipe.

Clause 17: The system of clause 15 or 16, wherein the metal substrate comprises a marine component.

Clause 18: The system of any of clauses 12-17, wherein the corrosion inhibiting composition is applied directly to the corrodible substrate, and the first wrap is applied directly over the corrosion inhibiting composition.

Clause 19: The system of any of clauses 12-18, wherein the corrosion inhibiting composition is impregnated into the first wrap, and the impregnated first wrap is applied directly over the corrodible substrate.

Clause 20: The system of any of clauses 12-19, wherein the corrosion inhibiting composition comprises a corrosion inhibitor configured to stop a corrosion-related reaction at a surface of the corrodible substrate over which the corrosion inhibiting composition is applied.

Clause 21: The system of any of clauses 12-20, wherein the corrosion inhibiting composition comprises: a hydrotreated paraffinic petroleum distillate; and/or mineral spirits and crystalline silica.

Clause 22: The system of any of clauses 13-21, wherein the coating composition comprises at least one of the following: a one-component polysiloxane composition, a one-component epoxy composition, a two-component epoxy composition, a (poly)urethane composition, a silicone composition, a rubberized composition, a fluoropolymer composition, a ceramic composition, a silicone-based conformal composition, and/or any combination thereof.

### BRIEF DESCRIPTION OF THE DRAWINGS

Additional advantages and details are explained in greater detail below with reference to the non-limiting, exemplary embodiments that are illustrated in the accompanying schematic figures, in which:

FIGS. 1A, 2A, 3A, and 4A show cross-sectional front views of a top half of a pipe comprising a corrosion inhibiting system according to non-limiting embodiments or aspects;

FIGS. 1B, 2B, 3B, and 4B show cross-sectional front views of a pipe comprising a corrosion inhibiting system according to non-limiting embodiments or aspects; and

FIGS. 1C, 2C, 3C, and 4C show perspective cutaway views of a pipe comprising a corrosion inhibiting system according to non-limiting embodiments or aspects.

### DETAILED DESCRIPTION

For purposes of the following detailed description, it is understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in its respective testing measurement.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. Further, in this application, the use of “a” or “an” means “at least one” unless specifically stated otherwise.

As used herein, the transitional term “comprising” (and other comparable terms, e.g., “containing” and “including”) is “open-ended” and open to the inclusion of unspecified matter. Although described in terms of “comprising”, the terms “consisting essentially of” and “consisting of” are also within the scope of the disclosure.

The present disclosure is directed to a method for protecting a corrodible substrate, comprising: applying a corrosion inhibiting composition to a corrodible substrate with a first wrap; and applying a second wrap over the first wrap, the second wrap comprising an uncured resin configured to be cured after applying the second wrap over the first wrap.

The present disclosure is also directed to a corrosion inhibiting system, comprising: a corrosion inhibiting composition and a first wrap configured to be applied over a corrodible substrate; and a second wrap configured to be applied over the first wrap, the second wrap comprising an uncured resin configured to be cured after applying the second wrap over the first wrap.

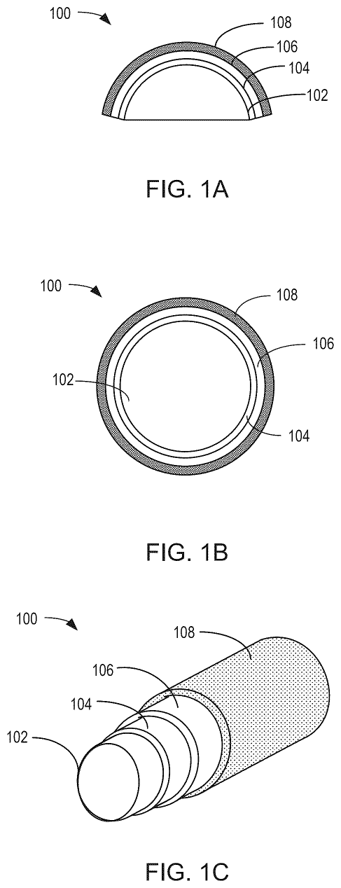

Referring to FIGS. 1A-1C, a corrosion inhibiting system 100 is shown according to some non-limiting embodiment or aspects. Corrosion inhibiting system 100 may comprise a corrodible substrate 102. Corrodible substrate 102 may comprise any suitable substrate that may corrode when exposed to a corrosion-inducing environment. For example, corrodible substrate 102 may comprise a metal substrate comprising a metal and/or a metal alloy that may corrode in a corrosion-inducing environment. The metal and/or metal alloy may comprise a non-noble metal, such as at least one of the following: brass, copper, iron, and/or any combination thereof. The metal and/or metal alloy may comprise steel. Corrosion-inducing environments may cause the metal substrate to corrode, such as by an electrochemical oxidation of the metal. Although metal substrates and electrochemical oxidation are provided as examples of corrodible substrates 102 and corrosion-inducing environments, it will be appreciated that other substrates and/or environments may be used.

In some non-limiting embodiments or aspects in which corrodible substrate 102 comprises a metal substrate, the metal substrate may comprise a metal pipe. However, other metal substrates are envisioned, including any metal substrate that may be exposed to corrosion-inducing environments. For example, the metal substrate may comprise at least one of the following: a metal beam, a metal rod, a metal bushing, a metal fastener, a metal railing, and the like. In the non-limiting examples of corrosion inhibiting system 100 from FIGS. 1A-1C, the corrodible substrate 102 comprises a metal pipe.

In some non-limiting embodiments or aspects, corrodible substrate 102 may comprise a marine component, which is commonly exposed to harsh, corrosion-inducing environments. For example, the marine component may comprise a marine vehicle (e.g., ship, submarine, or other form of watercraft). In some non-limiting embodiments or aspects, corrodible substrate 102 may comprise at least one of the following: a vehicle component, an architectural component, an aerospace component, an agricultural component, an infrastructure component, an energy industry-related component, a miliary component, a mining component, a sporting component, an electronic component, a medical component, and the like.

With continued reference to FIGS. 1A-1C, corrosion inhibiting system 100 may comprise a corrosion inhibiting composition 104 applied over corrodible substrate 102. Corrosion inhibiting composition 104 may be applied directly over a surface of corrodible substrate 102. Corrosion inhibiting composition 104 may form a continuous coating layer and/or a discontinuous treatment layer over the surface of corrodible substrate 102. Corrosion inhibiting composition 104 may be applied over corrodible substrate 102 using any suitable technique, such as brushing, rolling, spray coating, dip coating, or the like. Corrosion inhibiting composition 104 may comprise a liquid composition that dries to form the continuous and/or discontinuous layer.

Corrosion inhibiting composition 104 may comprise any composition configured to inhibit corrosion. By “inhibit” corrosion, it is meant that the composition slows and/or altogether prevents corrosion compared to the same corrodible substrate 102 except not having corrosion inhibiting composition 104 applied thereto.

In some non-limiting embodiments or aspects, corrosion inhibiting composition 104 may comprise a hydrotreated paraffinic petroleum distillate (e.g., CorrosionX Aviation from Corrosion Technologies (Garland, TX)), a mixture of mineral spirits and crystalline silica (e.g., CorrosionX Heavy Duty from Corrosion Technologies (Garland, TX)), and/or any combination thereof. Corrosion inhibiting composition 104 may comprise any material capable of stopping at least one of the following four elements needed for a metal to corrode: (1) polar bonding to an anode by passivating the surface to cancel (−); (2) polar bonding to a cathode by passivating the surface to cancel (+); (3) disrupting the path of current with a large dielectric (e.g., >39,000 V, as determined using ASTM D877, which result indicates the voltage at which electrical breakdown occurs); (4) isolating the metal from corrosion-causing electrolytes (e.g., water, salt, acid, and the like). Corrosion inhibiting composition 104 may stop effects (1)-(2) by polar bonding to the anode and cathode, thus causing the metal and/or metal alloy to behave more like a noble metal. Corrosion inhibiting composition 104 may stop all elements (1)-(4) needed for a metal to corrode.

The presence of corrosion inhibiting composition 104 on the surface of corrodible substrate 102 may inhibit corrosion on the surface. For example, corrosion inhibiting composition 104 may comprise a corrosion inhibitor configured to stop a corrosion-related reaction at a surface of corrodible substrate 102 over which the corrosion inhibiting composition 104 is applied. Stopping the corrosion-related reaction may comprise preventing the corrosion-related reaction from occurring at all, stopping continuation of an already-started corrosion-related reaction, slowing the rate of an already-started corrosion-related reaction, or some combination thereof. Stopping the corrosion-related reaction may comprise corrosion inhibiting composition 104 stopping at least one of elements (1)-(4) needed for a metal to corrode, as previously described. In stopping the corrosion-related reaction, corrosion inhibiting composition 104 may be at least partially consumed (e.g., reacted into a different compound).

With continued reference to FIGS. 1A-1C, a first wrap 106 may be applied over corrodible substrate 102. In the non-limiting example shown in FIGS. 1A-1C, first wrap 106 may be applied directly over corrosion inhibiting composition 104, which was applied directly over corrodible substrate 102. First wrap 106 may protect corrosion inhibiting composition 104 from the environment and/or promote contact between corrosion inhibiting composition 104 and the surface of corrodible substrate 102. In some non-limiting embodiments or aspects, first wrap 106 may comprise an adhesive on a surface thereof that promotes adhesion between first wrap 106 and corrodible substrate 102. In some non-limiting embodiments or aspects, first wrap 106 may comprise a felt (e.g., fabric and/or cloth) tape and/or ribbon, a fiberglass tape and/or ribbon, and/or the like.

First wrap 106 may be wrapped around corrodible substrate 102 using a spiral wrap technique with overlap for complete coverage. First wrap 106 may be at least partially overwrapped with itself to prevent formation of a gap exposing corrodible substrate 102.

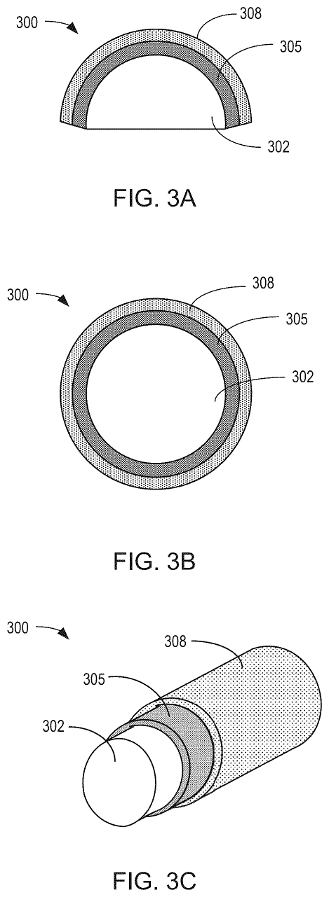

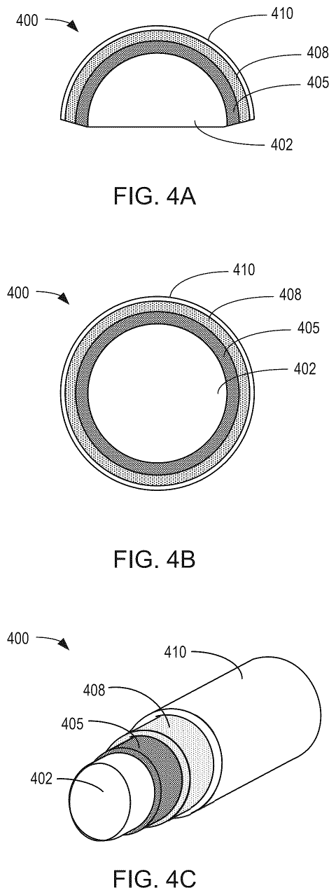

In some non-limiting embodiments or aspects, first wrap 106 may be the impregnated first wrap (see e.g., impregnated first wrap 305, 405 in FIG. 3A-4C) applied over corrosion inhibiting composition 104.

With continued reference to FIGS. 1A-1C, corrosion inhibiting system 100 may comprise a second wrap 108 applied over first wrap 106. In some non-limiting embodiments or aspects, second wrap 108 may comprise an adhesive on a surface thereof that promotes adhesion between second wrap 108 and first wrap 106. Second wrap 108 may comprise an uncured resin configured to be cured (e.g., moisture cured) after applying second wrap 108 over first wrap 106.

Second wrap 108 may comprise a wrap impregnated with the uncured resin, such as the wrap absorbing the uncured resin. The wrap of second wrap 108 may comprise a felt tape and/or ribbon, a fiberglass tape and/or ribbon, and/or the like.

Uncured resin may comprise a resin configured to cure, so as to harden second wrap 108 upon curing of the resin. For example, curing may comprise moisture curing the uncured resin when exposed to an environment configured to induce moisture curing (e.g., the atmosphere). The environment may comprise air having some degree of humidity (e.g., water vapor in air). Water (e.g., a mist and/or stream) may be applied to second wrap 108 to accelerate moisture curing of uncured resin. Curing may comprise providing an activator (e.g., baking soda or other suitable activator) to initiate curing of the uncured resin. Curing may comprise applying heat to initiate curing of the uncured resin. Any combination of these curing techniques may be used. Non-limiting examples of the uncured resin may comprise at least one of the following: a moisture curing urethane, a silicone, a rubberized coating, an epoxy, a cyanoacrylate acrylic adhesive, and/or any combination thereof.

Second wrap 108 comprising uncured resin may be applied over first wrap 106 and then cured. By the curing, second wrap 108 may harden to form a harder surface compared to the uncured wrap. Second wrap 108 may be exposed to the environment in which the uncured resin cures. Hardening of second wrap 108 by curing may allow second wrap 108 to protect lower layers of corrosion inhibiting system 100, such as first wrap 106 and/or corrosion inhibiting composition 104. The hardened second wrap 108 may protect lower layers of corrosion inhibiting system 100 from at least one of: physical contact with the surroundings, environmental conditions (e.g., UV exposure, water damage, seawater, humidity, and the like), and the like. The hardened second wrap 108 may also enable corrosion inhibiting system 100 to be painted and prevent cracking of that paint, which allows for further protection of corrosion inhibiting system 100 or for aesthetic modification to corrosion inhibiting system 100.

Second wrap 108 may be wrapped around first wrap 106 using a spiral wrap technique with overlap for complete coverage. Second wrap 108 may be at least partially overwrapped with itself to prevent formation of a gap exposing corrodible substrate 102.

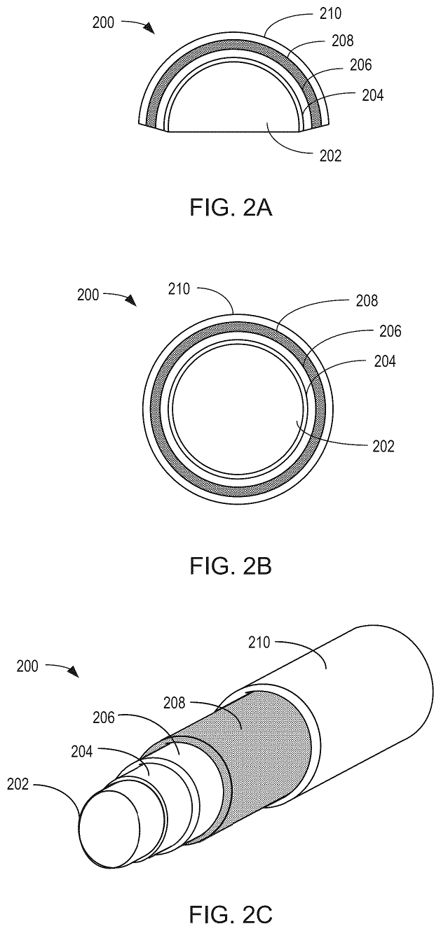

Referring to FIGS. 2A-2C, corrosion inhibiting system 200 thereof may share the same or similar characteristics compared to corrosion inhibiting system 100 of FIGS. 1A-1C except as described hereinafter. Corrodible substrate 202, corrosion inhibiting composition 204, first wrap 206, and second wrap 208 may correspond to and include the same or similar features compared to corrodible substrate 102, corrosion inhibiting composition 104, first wrap 106, and second wrap 108 of FIGS. 1A-1C.

Compared to corrosion inhibiting system 100 of FIGS. 1A-1C, corrosion inhibiting system 200 of FIGS. 2A-2C may further comprise a coating composition 210 applied over the cured second wrap 208. Coating composition 210 may be applied over second wrap 208 after second wrap 208 has been cured. Applying coating composition 210 over second wrap 208 before second wrap 208 has been cured may cause cracking of the applied coating composition 210 as second wrap 208 hardens from curing. Coating composition 210 may be applied to further protect lower layers of corrosion inhibiting system 200 and/or to aesthetically change the visual appearance of corrosion inhibiting system 200.

Coating composition 210 may be applied over the cured second wrap 208 using any suitable technique, such as brushing, rolling, spray coating, dip coating, or the like. Coating composition 210 may comprise a liquid composition that dries to form a coating layer. Coating layer may have a dry film thickness ranging from 2-10 mils, such as from 4-8 mils.

Non-limiting examples of coating composition 210 comprise at least one of the following: a one-component polysiloxane composition, a one-component epoxy composition, a two-component epoxy composition, a (poly)urethane composition, a silicone composition, a rubberized composition, a fluoropolymer composition (e.g., polytetrafluoroethylene (PTFE), fluorinated ethylene propylene (FEP), perfluoroalkoxy alkane (PFA)), a ceramic composition, a silicone-based conformal composition, and/or any combination thereof. For example, coating composition 210 may comprise a one-component polysiloxane composition.

Coating composition 210 comprising a urethane composition may result in a coating with excellent flexibility, impact resistance, and chemical resistance. Coating composition 210 comprising a two-component epoxy composition may result in a coating with excellent durability, chemical resistance, and corrosion resistance. Coating composition 210 comprising a silicone composition may result in a coating with excellent heat resistance, flexibility, and moisture resistance. Coating composition 210 comprising a rubberized coating may result in a coating with excellent protection, flexibility, impact absorption, and moisture resistance. Coating composition 210 comprising a fluoropolymer may result in a coating with excellent non-stick properties, water resistance, and chemical resistance. Coating composition 210 comprising a ceramic may result in a coating with excellent heat resistance and abrasion resistance. Coating composition 210 comprising a polyurethane may result in a coating with excellent flexibility, abrasion resistance, and moisture protection. Coating composition 210 comprising a silicone-based conformal composition may result in a coating with excellent sealing properties against moisture and contaminants, such as might be advantageous in sealing electronic components.

Referring to FIGS. 3A-3C, corrosion inhibiting system 300 thereof may share the same or similar characteristics compared to corrosion inhibiting system 100 of FIGS. 1A-1C except as described hereinafter. Corrodible substrate 302 and second wrap 308 may correspond to and include the same or similar features compared to corrodible substrate 102 and second wrap 108 of FIGS. 1A-1C.

Compared to corrosion inhibiting system 100 of FIGS. 1A-1C, corrosion inhibiting system 300 of FIGS. 3A-3C may comprise impregnated first wrap 305 between corrodible substrate 302 and second wrap 308. Impregnated first wrap 305 may comprise the first wrap as previously described impregnated with the corrosion inhibiting composition as previously described. First wrap may be impregnated with corrosion inhibiting composition and optionally one or more carriers to form impregnated first wrap 305 by applying the composition to first wrap, such as by soaking first wrap in the composition. The composition may be absorbed by the first wrap to form impregnated first wrap 305. For example, impregnated first wrap 305 may comprise a felt tape and/or ribbon impregnated with corrosion inhibiting composition and optionally one or more carriers.

Impregnated first wrap 305 may be applied directly to corrodible substrate 302. Second wrap 308 may be applied directly to impregnated first wrap 305.

Referring to FIGS. 4A-4C, corrosion inhibiting system 400 thereof may share the same or similar characteristics compared to corrosion inhibiting system 300 of FIGS. 3A-3C except as described hereinafter. Corrodible substrate 402, impregnated first wrap 405, and second wrap 408 may correspond to and include the same or similar features compared to corrodible substrate 302, impregnated first wrap 305, and second wrap 308 of FIGS. 3A-3C.

Compared to corrosion inhibiting system 300 of FIGS. 3A-3C, corrosion inhibiting system 400 of FIGS. 4A-4C may further comprise coating composition 410 applied over the cured second wrap 408. Coating composition 410 may share the same or similar characteristics as coating composition 210 described in connection with FIGS. 2A-2C. Coating composition 410 may be applied over second wrap 408 after second wrap 408 has been cured. Coating composition 410 may be applied to further protect lower layers of corrosion inhibiting system 400 and/or to aesthetically change the visual appearance of corrosion inhibiting system 400.

The present disclosure is also directed to methods for protecting a corrodible substrate. The corrodible substrate may be protected by preparing corrosion inhibiting systems as described herein.

Referring to FIGS. 1A-2C, corrosion inhibiting systems 100, 200 may be prepared by providing corrodible substrate 102, 202. Corrosion inhibiting composition 104, 204 may be applied to corrodible substrate 102, 202 with first wrap 106, 206. For example, corrosion inhibiting composition 104, 204 may be applied to corrodible substrate 102, 202, such as directly to corrodible substrate 102, 202. First wrap 106, 206 may be applied over corrosion inhibiting composition 104, 204. Second wrap 108, 208 may be applied over first wrap 106, 206. Second wrap 108, 208 may be exposed to an environment configured to cure second wrap 108, 208, such as an environment in which uncured resin of second wrap 108, 208 cures. Second wrap 108, 208 may be cured after applying second wrap 108, 208 over first wrap 106, 206. As shown in FIGS. 2A-2C, coating composition 210 may be applied to cured second wrap 208 to form a coating layer thereover.

Referring to FIGS. 3A-4C, corrosion inhibiting systems 300, 400 may be prepared by providing corrodible substrate 302, 402. Corrosion inhibiting composition may be applied to corrodible substrate 302, 402 with first wrap. For example, first wrap may be impregnated with corrosion inhibiting composition to form impregnated first wrap 305, 405. Impregnated first wrap 305, 405 may be applied to corrodible substrate 302, 402, such as directly to corrodible substrate 302, 402. Second wrap 308, 408 may be applied over impregnated first wrap 305, 405. Second wrap 308, 408 may be exposed to an environment configured to cure second wrap 308, 408, such as an environment in which uncured resin of second wrap 308, 408 cures. Second wrap 308, 408 may be cured after applying second wrap 308, 408 over impregnated first wrap 305, 405. As shown in FIGS. 4A-4C, coating composition 410 may be applied to cured second wrap 408 to form a coating layer thereover.

It will be appreciated that the Examples shown in FIGS. 1A-4C are non-limiting, and further additional layers may be included in some non-limiting embodiments or aspects. In some non-limiting embodiments or aspects, first wrap may be applied directly over the corrodible substrate, or first wrap may be applied indirectly over the corrodible substrate with one or more intervening layers arranged therebetween. In some non-limiting embodiments or aspects, second wrap may be applied directly over the first wrap, or second wrap may be applied indirectly over the first wrap with one or more intervening layers arranged therebetween. In some non-limiting embodiments or aspects, second wrap may be the outermost wrap layer, optionally coated with one or more coating layers applied thereover. In some non-limiting embodiments, one or more additional wrap layer may be arranged directly or indirectly over the second wrap.

### EXAMPLES

The following examples are presented to demonstrate the general principles of the disclosure. The disclosure should not be considered to be limited to the specific examples presented.

### Example 1 Salt Fog Corrosion Testing

A steel pipe was cut into 8-in sections. Plastic caps were affixed to both ends of the pipe sections to prevent ingress of the test solution. A NavWrap protective tape was applied to the pipe surface as an impregnated first wrap with a half-lap wrapping technique to ensure complete coverage.

These test specimens were placed in a Q-FOG Series 33 Chamber. Conditions of the chamber were operated according to ASTM B117 standards, maintaining a consistent saline mist environment. The specimens were continuously exposed to the salt fog environment for an extended duration (3,000 hours). The specimens were periodically monitored for signs of corrosion, delamination, and/or degradation of the protective tape over the duration. The test demonstrated that the protective tape of the impregnated first wrap provided exceptional corrosion resistance and maintained adhesion and integrity beyond 3,000 hours of salt fog exposure.

### Example 2 Impact Testing

Steel pipe was wrapped with fiberglass, urethane-impregnated tape as the second wrap. The tape was applied with a ¾ lap wrap pattern. One end of the pipe was fixed, while the other end was free to simulate real-world conditions where an impacted pipe might be partially restrained. A flat-faced wood board was used as the impactor to replicate the broad, blunt surface of a hard shoe sole. A 5 lb. weight was dropped from 3 ft to achieve an impact energy of 15 ft-lbs. The weight was guided to ensure a controlled vertical free fall onto the pipe's surface.

To execute the test, the pipe was secured as described. The flat-faced impactor was positioned directly above the test location of the wrapped pipe. The 5 lb. weight was lifted to a height 3 ft above the impact point. The weight was released to allow it to free fall and strike the impactor plate. The second wrap's surface was examined for cracks, fractures, and/or delaminations. No visible cracking in the wrapped protective layer was observed during the testing.

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

What is claimed is:

1. A method for protecting a corrodible substrate, comprising:
applying a corrosion inhibiting composition to the corrodible substrate with a first wrap;
applying a second wrap over the first wrap, the second wrap comprising an uncured resin configured to be cured after applying the second wrap over the first wrap.

2. The method of claim 1, further comprising applying a coating composition over the cured second wrap.

3. The method of claim 1, wherein the corrodible substrate comprises a metal substrate.

4. The method of claim 3, wherein the metal substrate comprises a metal pipe.

5. The method of claim 3, wherein the metal substrate comprises a marine component.

6. The method of claim 1, wherein applying the corrosion inhibiting composition to the corrodible substrate with the first wrap comprises:
applying the corrosion inhibiting composition directly to the corrodible substrate; and
applying the first wrap over the corrosion inhibiting composition.

7. The method of claim 1, wherein applying the corrosion inhibiting composition to the corrodible substrate with the first wrap comprises:
impregnating the first wrap with the corrosion inhibiting composition; and
applying the impregnated first wrap directly over the corrodible substrate.

8. The method of claim 1, wherein the corrosion inhibiting composition comprises a corrosion inhibitor configured to stop a corrosion-related reaction at a surface of the corrodible substrate over which the corrosion inhibiting composition is applied.

9. The method of claim 1, wherein the corrosion inhibiting composition comprises:
a hydrotreated paraffinic petroleum distillate; and/or
mineral spirits and crystalline silica.

10. The method of claim 2, wherein the coating composition comprises at least one of the following: a one-component polysiloxane composition, a one-component epoxy composition, a two-component epoxy composition, a (poly)urethane composition, a silicone composition, a rubberized composition, a fluoropolymer composition, a ceramic composition, a silicone-based conformal composition, and/or any combination thereof.

11. The method of claim 1, further comprising:
exposing the second wrap to an environment in which the uncured resin moisture cures.

12. A corrosion inhibiting system, comprising:
a corrosion inhibiting composition and a first wrap configured to be applied over a corrodible substrate;
a second wrap configured to be applied over the first wrap, the second wrap comprising an uncured resin configured to be cured after applying the second wrap over the first wrap.

13. The system of claim 12, further comprising:
a coating composition applied over the cured second wrap.

14. The system of claim 12, further comprising:
the corrodible substrate, the corrosion inhibiting composition and the first wrap applied over the corrodible substrate.

15. The system of claim 12, wherein the corrodible substrate comprises a metal substrate.

16. The system of claim 15, wherein the metal substrate comprises a metal pipe.

17. The system of claim 15, wherein the metal substrate comprises a marine component.

18. The system of claim 12, wherein the corrosion inhibiting composition is applied directly to the corrodible substrate, and the first wrap is applied directly over the corrosion inhibiting composition.

19. The system of claim 12, wherein the corrosion inhibiting composition is impregnated into the first wrap, and the impregnated first wrap is applied directly over the corrodible substrate.

20. The system of claim 12, wherein the corrosion inhibiting composition comprises a corrosion inhibitor configured to stop a corrosion-related reaction at a surface of the corrodible substrate over which the corrosion inhibiting composition is applied.
